(19) United States
(12) Patent Application Publication
(10) Pub. No.: US 2026/0245580 A1
(43) Pub. Date: Aug. 20, 2026

(54) MAGNETIC RECORDING DEVICE AND METHOD FOR CONTROLLING MAGNETIC RECORDING DEVICE

(71) Applicants: Kabushiki Kaisha Toshiba, Kawasaki-shi (JP); Toshiba Electronic Devices & Storage Corporation, Kawasaki-shi (JP)

(72) Inventors: Kosuke Kurihara, Yokohama Kanagawa (JP); Yousuke Isowaki, Yokohama Kanagawa (JP); Akira Kikitsu, Yokohama Kanagawa (JP); Ryo Osamura, Kawasaki Kanagawa (JP); Tazumi Nagasawa, Yokohama Kanagawa (JP); Yuki Saito, Fuchu Tokyo (JP)

(21) Appl. No.: 19/532,877

(22) Filed: Feb. 6, 2026

(30) Foreign Application Priority Data
Feb. 20, 2025 (JP) 2025-026175

(51) Int. Cl. G11B 5/012

(52) U.S. Cl. CPC G11B 5/012

(57) ABSTRACT

According to one embodiment, a magnetic recording device includes a magnetic recording medium, a magnetic head to record information on the magnetic recording medium, and a controller to control the magnetic recording medium and the magnetic head. The magnetic head includes a coil, a first magnetic pole to generate a magnetic field, and a light emitting portion to irradiate the magnetic recording medium with light. The controller performs first and second operations. In the first operation, the controller supplies a first current to the light emitting portion to emit a first light to cause the first magnetic pole to record information on the magnetic recording medium. In the second operation, the controller supplies a second current to the light emitting portion to emit a second light to change a state of a contaminated member attached to the magnetic head. The second current is greater than the first current.

### CROSS-REFERENCE TO RELATED APPLICATIONS

This application is based upon and claims the benefit of priority from Japanese Patent Application No.2025-026175, filed on Feb. 20, 2025; the entire contents of which are incorporated herein by reference.

### FIELD

Embodiments described herein relate generally to a magnetic recording device and a method for controlling a magnetic recording device.

### BACKGROUND

In a magnetic recording device, information is recorded on a magnetic recording medium such as a hard disk drive (HDD) by using a magnetic head. Stable operation is desired in the magnetic recording device.

### BRIEF DESCRIPTION OF THE DRAWINGS

FIGS. 1A and 1B are schematic diagrams illustrating a magnetic recording device according to a first embodiment;

FIG. 2 is a schematic plan view illustrating the magnetic recording device according to the first embodiment;

FIG. 3 is a schematic diagram illustrating the magnetic recording device according to the first embodiment;

FIG. 4 is a flowchart illustrating the operation of the magnetic recording device according to the first embodiment;

FIGS. 5A to 5D are schematic diagrams illustrating the operation of the magnetic recording device according to the first embodiment;

FIG. 6 is a schematic perspective view illustrating the magnetic head and magnetic recording device according to the embodiment;

FIG. 7 is a schematic perspective view illustrating a part of the magnetic recording device according to the embodiment;

FIG. 8 is a schematic perspective view illustrating the magnetic recording device according to the embodiment; and

FIGS. 9A and 9B are schematic perspective views illustrating a part of the magnetic recording device according to the embodiment.

### DETAILED DESCRIPTION

According to one embodiment, a magnetic recording device includes a magnetic recording medium, a magnetic head configured to record information on the magnetic recording medium, and a controller configured to control the magnetic recording medium and the magnetic head. The magnetic head includes a coil, a first magnetic pole configured to generate a magnetic field according to a recording current supplied to the coil, and a light emitting portion configured to irradiate the magnetic recording medium with light to locally increase a temperature of the magnetic recording medium. The controller is configured to perform a first operation and a second operation. In the first operation, the controller is configured to supply a first current to the light emitting portion to emit a first light to cause the first magnetic pole to record information on the magnetic recording medium. In the second operation, the controller is configured to supply a second current to the light emitting portion to emit a second light to change a state of a contaminated member attached to the magnetic head. The second current is greater than the first current.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

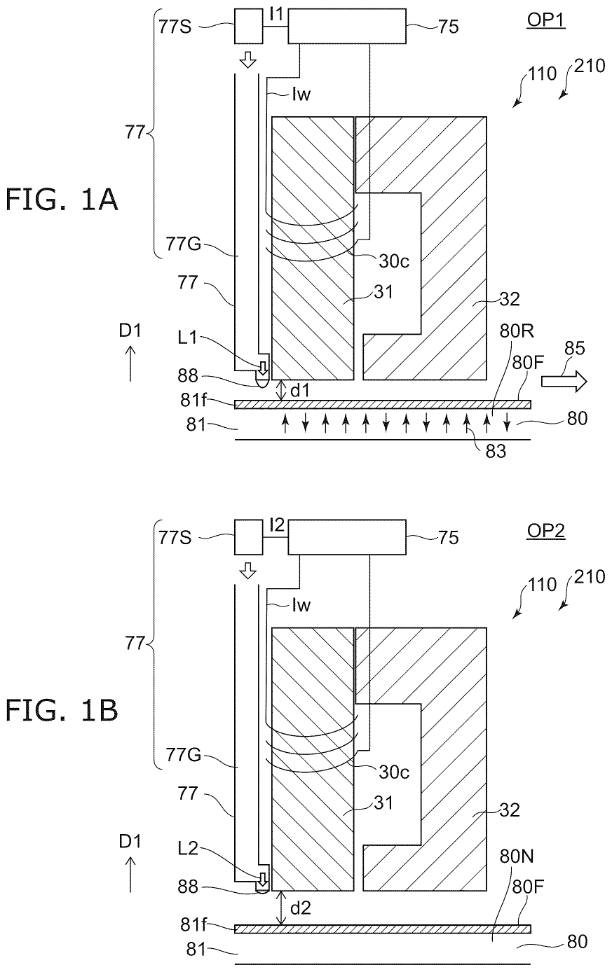

FIGS. 1A and 1B are schematic diagrams illustrating a magnetic recording device according to a first embodiment.

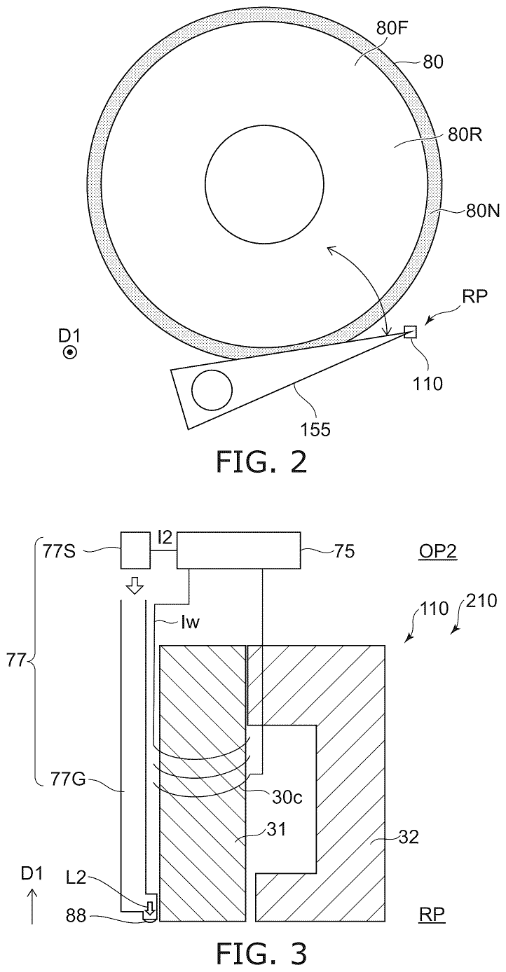

FIG. 2 is a schematic plan view illustrating the magnetic recording device according to the first embodiment.

FIG. 3 is a schematic diagram illustrating the magnetic recording device according to the first embodiment.

As shown in FIG. 1A, a magnetic recording device 210 according to the embodiment includes a magnetic recording medium 80, a magnetic head 110, and a controller 75. The magnetic head 110 is configured to record information on the magnetic recording medium 80. The controller 75 is configured to control the magnetic recording medium 80 and the magnetic head 110.

The magnetic head 110 includes a coil 30c and a first magnetic pole 31. The first magnetic pole 31 generates a magnetic field (recording magnetic field) according to the recording current Iw supplied to the coil 30c. The generated magnetic field is applied to the magnetic recording medium 80. This controls the orientation of the magnetization 83 of the magnetic recording medium 80. The state of the magnetization 83 corresponds to the information to be recorded. In this example, the magnetic head 110 further includes a second magnetic pole 32. The first magnetic pole 31 is, for example, a main magnetic pole. The second magnetic pole 32 is, for example, a trailing shield. The magnetic recording medium 80 moves relative to the magnetic head 110 in a medium movement direction 85.

The magnetic head 110 further includes a light emitting portion 77. The light emitting portion 77 is configured to irradiate the magnetic recording medium 80 with light to locally increase the temperature of the magnetic recording medium 80.

For example, the light emitting portion 77 includes a light source 77S and a light guide 77G. The light emitted from the light source 77S is guided by the light guide 77G. The light emitted from the light guide 77G is emitted to the magnetic recording medium 80 via, for example, an optical element. The light source 77S is, for example, a laser.

Current (power) is supplied from the controller 75 to the light source 77S. The current (power) is variable. Light with an intensity according to the current (power) is emitted.

The controller 75 is configured to perform a first operation OP1 and a second operation OP2. FIG. 1A corresponds to the first operation OP1. FIG. 1B corresponds to the second operation OP2.

As shown in FIG. 1A, in the first operation OP1, the controller 75 is configured to supply a first current I1 to the light emitting portion 77 to emit a first light L1, and cause the first magnetic pole 31 to record information on the magnetic recording medium 80. The first operation OP1 corresponds to a recording operation.

In the first operation OP1, the first light L1 is locally irradiated onto the magnetic recording medium 80, and the temperature of the magnetic recording medium 80 rises locally. This locally changes the recording characteristics of the magnetic recording medium 80. Efficient recording is possible. The first operation OP1 corresponds to, for example, a thermally assisted recording operation.

As shown in FIG. 1B, in the second operation OP2, the controller 75 is configured to supply a second current I2 to the light emitting portion 77 to emit a second light L2, thereby changing a state of a contaminated member 88 attached to the magnetic head 110. The second current I2 is greater than the first current I1. For example, at least a part of the contaminated member 88 may be removed by the second operation OP2. The second operation OP2 corresponds to, for example, a cleaning operation.

The intensity of the second light L2 in the second operation OP2 in which the second current I2 is supplied is higher than the intensity of the first light L1 in the first operation OP1. This causes a change in the state of the contaminated member 88. For example, the hardness of the contaminated member 88 decreases. For example, the adhesive force of the contaminated member 88 decreases. For example, the shape of the contaminated member 88 changes. For example, a part of the contaminated member 88 evaporates. For example, at least a part of the contaminated member 88 is removed.

If the first operation OP1 (recording operation) is performed in a state in which the contaminated member 88 is attached, it becomes difficult for the first light L1 being intended to be irradiated onto the magnetic recording medium 80. For example, the intensity of the first light L1 irradiated onto the magnetic recording medium 80 decreases. For example, the directivity of the first light L1 decreases, and the first light L1 is incident on regions that are not the intended position. This makes it difficult to obtain a stable recording operation.

In the embodiment, the state of the contaminated member 88 changes by the second operation OP2. For example, at least a part of the contaminated member 88 is removed. Thereby, stable recording operations can be obtained. According to the embodiment, a magnetic recording device capable of stable operations can be provided.

The contaminated member 88 may include a material included in the magnetic recording medium 80. The contaminated member 88 may include a material resulting from a material included in the magnetic recording medium 80. For example, the magnetic recording medium 80 may include a magnetic recording layer 81 and a surface layer 81f. The surface layer 81f is provided on the magnetic recording layer 81. The surface layer 81f is, for example, a lubricating material layer. The contaminated member 88 may include, for example, a part of a material included in the surface layer 81f.

For example, the contaminated member 88 is generated in the first operation OP1. For example, the generation of the contaminated member 88 is accelerated by the first light L1 irradiated to the magnetic recording medium 80 in the first operation OP1.

In one example, the controller 75 may be configured to periodically perform the second operation OP2. For example, a state in which there are no or few contaminated member 88 can be maintained.

In the second operation OP2, no information is recorded on the magnetic recording medium 80. The state of the magnetic head 110 in the second operation OP2 is different from the state of the magnetic head 110 in the first operation OP1 of the recording operation.

As shown in FIG. 1A, a distance between the magnetic recording medium 80 and the magnetic head 110 in the first operation OP1 is defined as a first distance d1. As shown in FIG. 1B, a distance between the magnetic recording medium 80 and the magnetic head 110 in the second operation OP2 is defined as a second distance d2. In one example, the second distance d2 is longer than the first distance d1. The adverse effect of the second light L2 on the magnetic recording medium 80 in the second operation OP2 is suppressed.

As shown in FIG. 2, the magnetic head 110 can face any position on the magnetic recording medium 80 by an arm 155. For example, the magnetic recording medium 80 includes a recording region 80R and a non-recording region 80N. As shown in FIG. 1A, in the first operation OP1, the magnetic head 110 faces the recording region 80R. In one example, as shown in FIG. 1B, in the second operation OP2, the magnetic head 110 faces the non-recording region 80N.

As shown in FIG. 2, the magnetic head 110 has a ramp position RP. The ramp position RP is, for example, a standby position.

FIG. 3 illustrates a state in the second operation OP2. As shown in FIG. 3, in the second operation OP2, the magnetic head 110 may be at the ramp position RP. At the ramp position RP, vibration may be applied to the magnetic head 110. For example, the contaminated member 88 is effectively removed.

In one example, in the second operation OP2, the magnetic head 110 does not overlap the recording region 80R of the magnetic recording medium 80 in a first direction D1 perpendicular to a recording face 80F of the magnetic recording medium 80. The adverse effects of the second light L2 on the magnetic recording medium 80 in the second operation OP2 are suppressed.

In one example, the second current I2 may be not less than 1.1 times and not more than 2 times the first current I1. By the second current I2 being not less than 1.1 times the first current I1, the state of the contaminated member 88 can be changed efficiently. By the second current I2 being not more than 2 times the first current I1, deterioration of the characteristics of the magnetic head 110 is suppressed.

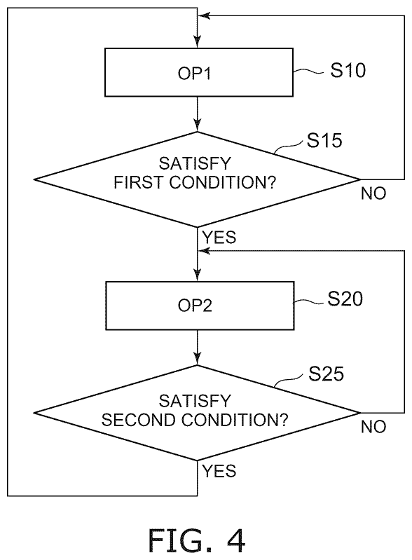

FIG. 4 is a flowchart illustrating the operation of the magnetic recording device according to the first embodiment.

As shown in FIG. 4, the controller 75 performs the first operation OP1 (step S10) and the second operation OP2 (step S20).

The controller 75 may determine whether a first condition is satisfied (step S15). The controller 75 is configured to perform the second operation OP2 in a case where the first condition is satisfied. In a case where the first condition is not satisfied, the first operation OP1 continues to be performed.

In one example, the first condition includes a time of the first operation OP1 reaching a reference time.

In another example, the first condition includes that a difference between the distance between the magnetic recording medium 80 and the magnetic head 110; and a reference distance exceeds a reference value. For example, in a case where the contaminated member 88 is not present, the distance between the magnetic recording medium 80 and the magnetic head 110 is short. For example, in a case where the contaminated member 88 is present, the distance between the magnetic recording medium 80 and the magnetic head 110 does not become equal to or less than the thickness of the contaminated member 88. The presence or absence of the contaminated member 88 or the amount of the contaminated member 88 can be estimated based on the distance between the magnetic recording medium 80 and the magnetic head 110.

As already described, the controller 75 may be configured to periodically perform the second operation OP2.

As shown in FIG. 4, the controller 75 may determine whether the second condition is satisfied. In a case where the second condition is not satisfied, the second operation OP2 is continued. In a case where the second condition is satisfied, the second operation OP2 is terminated. In this case, the first operation OP1 can be performed. In this manner, the controller 75 may be configured to continue the second operation OP2 until the second condition is satisfied.

In one example, the second condition includes the difference between the distance between the magnetic recording medium 80 and the magnetic head 110; and the reference distance being equal to or less than a reference value. For example, when the difference between the distance between the magnetic recording medium 80 and the magnetic head 110; and the reference distance becomes large, the contaminated member 88 remains. The second operation OP2 may be continued until the amount of the contaminated member 88 becomes less than a reference amount.

In another example, the second condition may include the duration of the second operation OP2 reaching a determined time. The second operation OP2 may be terminated by the elapsed time.

Below, an example of measuring the distance between the magnetic recording medium 80 and the magnetic head 110 will be described. In the following example, the distance between the magnetic recording medium 80 and the magnetic head 110 is controlled by the power supplied to the magnetic head 110.

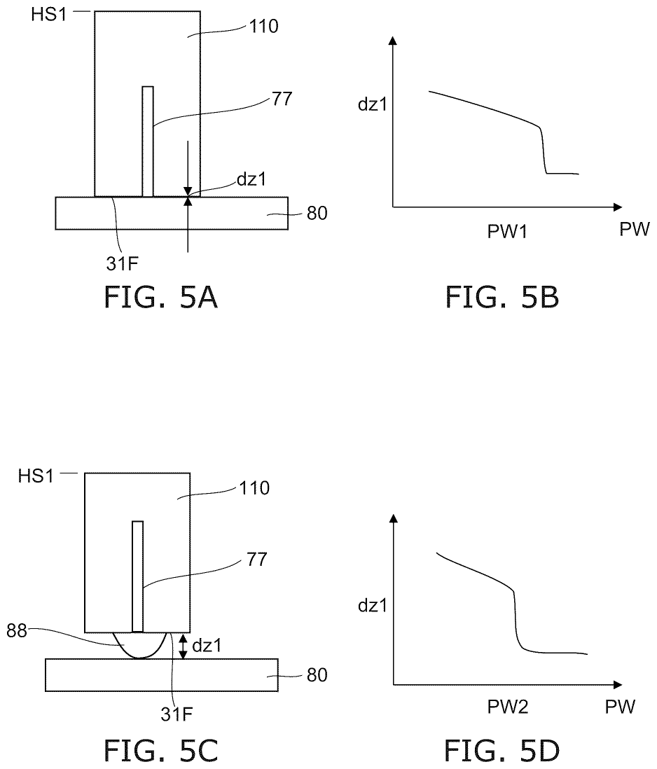

FIGS. 5A to 5D are schematic diagrams illustrating the operation of the magnetic recording device according to the first embodiment.

FIGS. 5A and 5B correspond to a state in which the contaminated member 88 is not present. The horizontal axis of FIG. 5B is the power PW supplied to the magnetic head 110. The vertical axis of FIG. 5B is a distance dz1 between the magnetic recording medium 80 and the magnetic head 110. The distance dz1 is the distance between a medium facing face 31F of the magnetic head 110 and the magnetic recording medium 80.

As shown in FIG. 5B, when the power PW is increased, the distance dz1 decreases due to the thermal expansion of the magnetic head 110. As shown in FIG. 5B, when the power PW reaches a first power PW1, the decrease in the distance dz1 becomes saturated. The first power PW1 corresponds to a state in which the medium facing face 31F and the magnetic recording medium 80 are substantially in contact. In this way, the distance dz1 can be measured by measuring the behavior regarding the change in the power PW.

FIGS. 5C and 5D correspond to a state in which the contaminated member 88 is present. The horizontal axis of FIG. 5D is the power PW supplied to the magnetic head 110. The vertical axis of FIG. 5D is the distance dz1 between the magnetic recording medium 80 and the magnetic head 110.

As shown in FIG. 5D, when the power PW is increased, the distance dz1 decreases due to thermal expansion of the magnetic head 110. As shown in FIG. 5D, when the power PW reaches a second power PW2, the decrease in the distance dz1 saturates. The second power PW2 corresponds to a state in which the medium facing face 31F and the contaminated member 88 are substantially in contact. The second power PW2 is smaller than the first power PW1.

By comparing the characteristics illustrated in FIG. 5B with the characteristics illustrated in FIG. 5D, the thickness (amount) of the contaminated member 88 can be measured. By measuring the behavior related to changes in power PW, the distance dz1 can be measured in a case where the contaminated member 88 is present.

In this way, the distance dz1 between the magnetic recording medium 80 and the magnetic head may change based on the power PW supplied to the magnetic head 110. The distance dz1 between the magnetic recording medium 80 and the magnetic head 110 may be measured based on the rate of change of power PW.

### Second Embodiment

The second embodiment relates to a control method for the magnetic recording device 210. The control method, for example, performs the process described with reference to FIG. 4.

For example, the first operation OP1 and the second operation OP2 are performed on the magnetic head 110 configured to record information on the magnetic recording medium 80. As already described, the magnetic head 110 includes the coil 30c, the first magnetic pole 31 configured to generate the magnetic field according to the recording current Iw supplied to the coil 30c, and the light emitting portion 77 configured to irradiate the magnetic recording medium 80 with light to locally increase the temperature of the magnetic recording medium 80.

In the first operation OP1, the first current I1 is supplied to the light emitting portion 77 to emit the first light L1, and the first magnetic pole 31 records information on the magnetic recording medium 80 (see FIG. 1A). In the second operation OP2, the second current I2 is supplied to the light emitting portion 77 to emit the second light L2, and the state of the contaminated member 88 attached to the magnetic head 110 is changed (see FIG. 1B). The second current I2 is greater than the first current I1. According to the embodiment, a method for controlling a magnetic recording device capable of stable operation is provided.

The configuration described in the first embodiment may be applied to the second embodiment. For example, in the second operation OP2, at least a part of the contaminated member 88 may be removed. For example, in the second operation OP2, the magnetic head 110 may be at the ramp position RP.

Below, examples of the configuration of the magnetic head 110 and the magnetic recording device 210 are described.

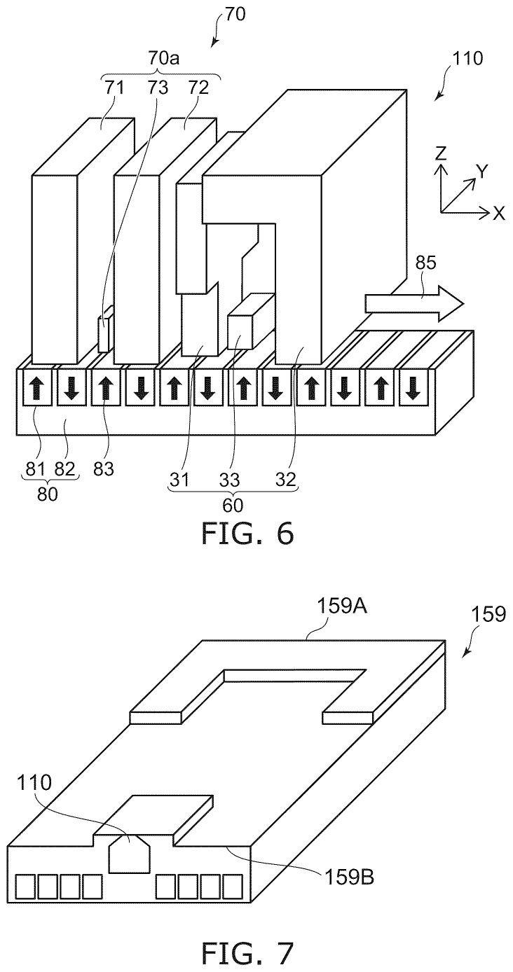

FIG. 6 is a schematic perspective view illustrating the magnetic head and magnetic recording device according to the embodiment.

In FIG. 6, the light emitting portion 77 is omitted.

As shown in FIG. 6, the magnetic head according to the embodiment (e.g., magnetic head 110) includes a reproducing section 70. The reproducing section 70 includes a first reproducing element 70a. The reproducing section 70 may further include other reproducing elements. The magnetic head 110 is used together with the magnetic recording medium 80. The magnetic head 110 may include a recording section 60. Information is recorded on the magnetic recording medium 80 by the recording section 60 of the magnetic head 110. The information recorded on the magnetic recording medium 80 is reproduced by the reproducing section 70.

The magnetic recording medium 80 includes, for example, a medium substrate 82 and a magnetic recording layer 81 provided on the medium substrate 82. The magnetization 83 of the magnetic recording layer 81 is controlled by the recording section 60. The recording section 60 includes, for example, a first magnetic pole 31 and a second magnetic pole 32. The first magnetic pole 31 is, for example, a main magnetic pole. The second magnetic pole 32 is, for example, a trailing shield. The recording section 60 may include a recording section element 33. The recording section element 33 may include a magnetic field control element or a high-frequency oscillation element. The recording section element 33 may be omitted.

The first reproducing element 70a of the reproducing section 70 includes, for example, a first reproducing shield 71, a second reproducing shield 72, and a reproducing element 73. The reproducing section 70 can output a signal corresponding to the magnetization 83 of the magnetic recording layer 81.

As shown in FIG. 6, the magnetic recording medium 80 moves relative to the magnetic head 110 in the medium movement direction 85. The magnetic head 110 controls information corresponding to the magnetization 83 of the magnetic recording layer 81 at any position. The magnetic head 110 reproduces information corresponding to the magnetization 83 of the magnetic recording layer 81 at any position.

For example, the medium movement direction 85 is a direction from the first reproducing shield 71 to the second reproducing shield 72. For example, the magnetic recording medium 80 includes a first recording region. After the first region faces the first reproducing shield 71, the first recording region faces the second reproducing shield 72.

FIG. 7 is a schematic perspective view illustrating a part of the magnetic recording device according to the embodiment.

FIG. 7 illustrates a head slider.

The magnetic head 110 is provided on a head slider 159. The head slider 159 includes, for example, Al₂O₃/TiC. The head slider 159 moves relative to the magnetic recording medium while flying over or in contact with the magnetic recording medium.

The head slider 159 has, for example, an air inflow side 159A and an air outflow side 159B. The magnetic head 110 is arranged on the side surface of the air outflow side 159B of the head slider 159. As a result, the magnetic head 110 moves relative to the magnetic recording medium while floating above or in contact with the magnetic recording medium.

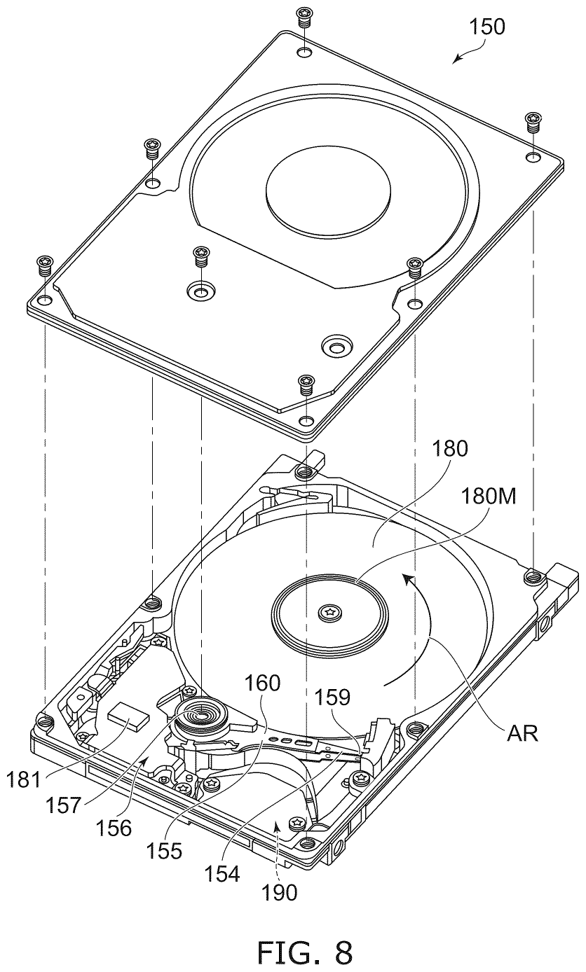

FIG. 8 is a schematic perspective view illustrating the magnetic recording device according to the embodiment.

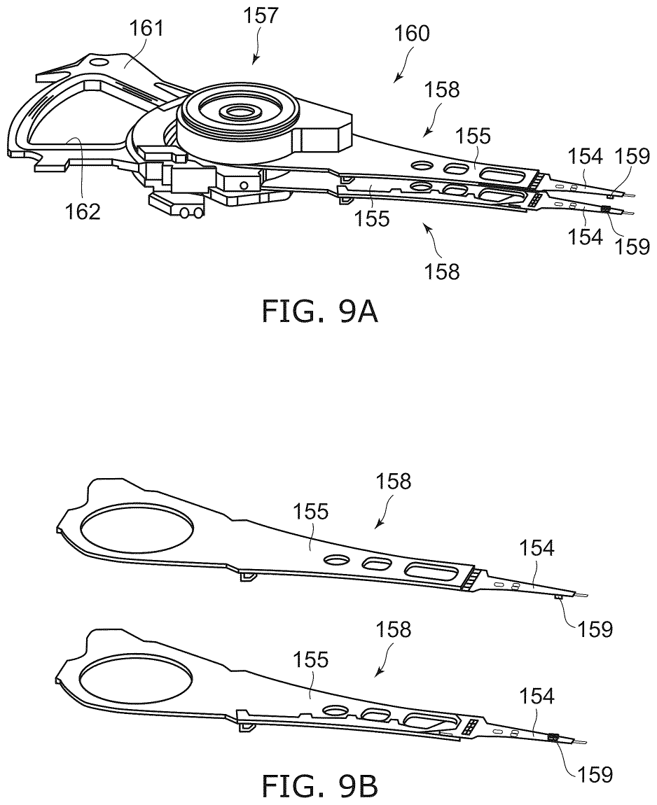

FIGS. 9A and 9B are schematic perspective views illustrating a part of the magnetic recording device according to the embodiment.

As shown in FIG. 8, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the plurality of recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 9A is an enlarged perspective view of the head stacked body assembly 160, illustrating the configuration of a part of the magnetic recording device.

FIG. 9B is a perspective view illustrating the magnetic head assembly (head gimbal assembly: HGA) 158 that forms part of the head stacked body assembly 160.

As shown in FIG. 9A, the head stacked body assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 9B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to a plurality of electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### Technical Proposal 1

A magnetic recording device, comprising:
a magnetic recording medium;
a magnetic head configured to record information on the magnetic recording medium; and
a controller configured to control the magnetic recording medium and the magnetic head,
the magnetic head including:
   a coil;
   a first magnetic pole configured to generate a magnetic field according to a recording current supplied to the coil; and
   a light emitting portion configured to irradiate the magnetic recording medium with light to locally increase a temperature of the magnetic recording medium,
the controller being configured to perform a first operation and a second operation,
in the first operation, the controller being configured to supply a first current to the light emitting portion to emit a first light to cause the first magnetic pole to record information on the magnetic recording medium, and
in the second operation, the controller being configured to supply a second current to the light emitting portion to emit a second light to change a state of a contaminated member attached to the magnetic head, and
the second current being greater than the first current.

### Technical Proposal 2

The magnetic recording device according to Technical proposal 1, wherein
at least a part of the contaminated member is removed in the second operation.

### Technical Proposal 3

The magnetic recording device according to Technical proposal 1, wherein
a shape of the contaminated member changes in the second operation.

### Technical Proposal 4

The magnetic recording device according to any one of Technical proposals 1-3, wherein
no information is recorded on the magnetic recording medium in the second operation.

### Technical Proposal 5

The magnetic recording device according to any one of Technical proposals 1-4, wherein
the contaminated member is generated in the first operation.

### Technical Proposal 6

The magnetic recording device according to any one of Technical proposals 1-5, wherein
in the second operation, the magnetic head does not overlap a recording region of the magnetic recording medium in a first direction perpendicular to a recording face of the magnetic recording medium.

### Technical Proposal 7

The magnetic recording device according to any one of Technical proposals 1-5, wherein
the magnetic head is in a ramp position in the second operation.

### Technical Proposal 8

The magnetic recording device according to any one of Technical proposals 1-5, wherein
a second distance between the magnetic recording medium and the magnetic head in the second operation is longer than a first distance between the magnetic recording medium and the magnetic head in the first operation.

### Technical Proposal 9

The magnetic recording device according to any one of Technical proposals 1-5, wherein
the magnetic recording medium includes a recording region and a non-recording region,
the magnetic head faces the recording region in the first operation, and
the magnetic head faces the non-recording region in the second operation.

### Technical Proposal 10

The magnetic recording device according to any one of Technical proposals 1-9, wherein
the controller is configured to perform the second operation when a first condition is satisfied, and
the first condition includes that a time of the first operation reaches a reference time.

### Technical Proposal 11

The magnetic recording device according to any one of Technical proposals 1-9, wherein
the controller is configured to perform the second operation when a first condition is satisfied, and
the first condition includes that a difference between a distance between the magnetic recording medium and the magnetic head; and a reference distance exceeds a reference value.

### Technical Proposal 12

The magnetic recording device according to any one of Technical proposals 1-9, wherein
the controller is configured to periodically perform the second operation.

### Technical Proposal 13

The magnetic recording device according to any one of Technical proposals 1-9, wherein
the controller is configured to continue the second operation until a second condition is satisfied, and
the second condition includes that a difference between the distance between the magnetic recording medium and the magnetic head; and a reference distance is equal to or less than a reference value.

### Technical Proposal 14

The magnetic recording device according to any one of Technical proposals 1-9, wherein
the controller is configured to continue the second operation until a second condition is satisfied, and
the second condition includes that the second operation reaches a determined time.

### Technical Proposal 15

The magnetic recording device according to any one of Technical proposals 1-14, wherein
the second current is not less than 1.1 times and not more than 2 times the first current.

### Technical Proposal 16

The magnetic recording device according to Technical proposal 11 or 13, wherein
the distance between the magnetic recording medium and the magnetic head changes based on a power supplied to the magnetic head, and
the distance between the magnetic recording medium and the magnetic head is measured based on a rate of change of the power.

### Technical Proposal 17

The magnetic recording device according to any one of Technical proposals 1-16, wherein
the contaminated member includes a material included in the magnetic recording medium.

### Technical Proposal 18

A method for controlling a magnetic recording device, the method comprising:
causing a magnetic head configured to record information on a magnetic recording medium to perform a first operation and a second operation, the magnetic head including a coil, a first magnetic pole configured to generate a magnetic field corresponding to a recording current supplied to the coil, and a light emitting portion configured to irradiate the magnetic recording medium with light to locally increase a temperature of the magnetic recording medium;
in the first operation, supplying a first current to the light emitting portion to emit a first light to cause the first magnetic pole to record information on the magnetic recording medium;
in the second operation, supplying a second current to the light emitting portion to emit a second light to change a state of a contaminated member attached to the magnetic head, and
the second current being greater than the first current.

### Technical Proposal 19

The method for controlling the magnetic recording device according to Technical proposal 18, wherein
at least a part of the contaminated member is removed in the second operation.

### Technical Proposal 20

The method for controlling the magnetic recording device according to Technical proposal 18 or 19, wherein
the magnetic head is in a ramp position in the second operation.

According to the embodiment, a magnetic recording device and a method for manufacturing a magnetic recording device can improve productivity can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic recording devices such as magnetic recording mediums, magnetic heads, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices and all methods for manufacturing magnetic recording devices practicable by an appropriate design modification by one skilled in the art based on the magnetic recording devices and the methods for manufacturing magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic recording device, comprising:
a magnetic recording medium;
a magnetic head configured to record information on the magnetic recording medium; and
a controller configured to control the magnetic recording medium and the magnetic head,
the magnetic head including:
a coil;
a first magnetic pole configured to generate a magnetic field according to a recording current supplied to the coil; and
a light emitting portion configured to irradiate the magnetic recording medium with light to locally increase a temperature of the magnetic recording medium,
the controller being configured to perform a first operation and a second operation,
in the first operation, the controller being configured to supply a first current to the light emitting portion to emit a first light to cause the first magnetic pole to record information on the magnetic recording medium, and
in the second operation, the controller being configured to supply a second current to the light emitting portion to emit a second light to change a state of a contaminated member attached to the magnetic head, and
the second current being greater than the first current.

2. The magnetic recording device according to claim 1, wherein
at least a part of the contaminated member is removed in the second operation.

3. The magnetic recording device according to claim 1, wherein
a shape of the contaminated member changes in the second operation.

4. The magnetic recording device according to claim 1, wherein
no information is recorded on the magnetic recording medium in the second operation.

5. The magnetic recording device according to claim 1, wherein
the contaminated member is generated in the first operation.

6. The magnetic recording device according to claim 1, wherein
in the second operation, the magnetic head does not overlap a recording region of the magnetic recording medium in a first direction perpendicular to a recording face of the magnetic recording medium.

7. The magnetic recording device according to claim 1, wherein
the magnetic head is in a ramp position in the second operation.

8. The magnetic recording device according to claim 1, wherein
a second distance between the magnetic recording medium and the magnetic head in the second operation is longer than a first distance between the magnetic recording medium and the magnetic head in the first operation.

9. The magnetic recording device according to claim 1, wherein
the magnetic recording medium includes a recording region and a non-recording region,
the magnetic head faces the recording region in the first operation, and
the magnetic head faces the non-recording region in the second operation.

10. The magnetic recording device according to claim 1, wherein
the controller is configured to perform the second operation when a first condition is satisfied, and
the first condition includes that a time of the first operation reaches a reference time.

11. The magnetic recording device according to claim 1, wherein
the controller is configured to perform the second operation when a first condition is satisfied, and
the first condition includes that a difference between a distance between the magnetic recording medium and the magnetic head; and a reference distance exceeds a reference value.

12. The magnetic recording device according to claim 1, wherein
the controller is configured to periodically perform the second operation.

13. The magnetic recording device according to claim 1, wherein
the controller is configured to continue the second operation until a second condition is satisfied, and
the second condition includes that a difference between the distance between the magnetic recording medium and the magnetic head; and a reference distance is equal to or less than a reference value.

14. The magnetic recording device according to claim 1, wherein
the controller is configured to continue the second operation until a second condition is satisfied, and
the second condition includes that the second operation reaches a determined time.

15. The magnetic recording device according to claim 1, wherein
the second current is not less than 1.1 times and not more than 2 times the first current.

16. The magnetic recording device according to claim 11, wherein
the distance between the magnetic recording medium and the magnetic head changes based on a power supplied to the magnetic head, and
the distance between the magnetic recording medium and the magnetic head is measured based on a rate of change of the power.

17. The magnetic recording device according to claim 1, wherein
the contaminated member includes a material included in the magnetic recording medium.

18. A method for controlling a magnetic recording device, the method comprising:
causing a magnetic head configured to record information on a magnetic recording medium to perform a first operation and a second operation, the magnetic head including a coil, a first magnetic pole configured to generate a magnetic field corresponding to a recording current supplied to the coil, and a light emitting portion configured to irradiate the magnetic recording medium with light to locally increase a temperature of the magnetic recording medium;
in the first operation, supplying a first current to the light emitting portion to emit a first light to cause the first magnetic pole to record information on the magnetic recording medium;
in the second operation, supplying a second current to the light emitting portion to emit a second light to change a state of a contaminated member attached to the magnetic head, and
the second current being greater than the first current.

19. The method for controlling the magnetic recording device according to claim 18, wherein
at least a part of the contaminated member is removed in the second operation.

20. The method for controlling the magnetic recording device according to claim 18, wherein
the magnetic head is in a ramp position in the second operation.
